(19) United States
(12) Patent Application Publication
(10) Pub. No.: US 2023/0231956 A1
(43) Pub. Date: Jul. 20, 2023

(54) INFORMATION PROCESSING APPARATUS, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Yuki ONO, Kanagawa (JP)

(73) Assignee: FUJIFILM Business Innovation Corp., Tokyo (JP)

(21) Appl. No.: 17/882,151

(22) Filed: Aug. 5, 2022

(30) Foreign Application Priority Data
Jan. 20, 2022 (JP) 2022-007061

(51) Int. Cl. H04N 1/00; G06V 30/22; G06V 30/30; G06V 30/41; H04N 1/34; G06Q 30/04

(52) U.S. Cl. CPC H04N 1/00331; G06V 30/22; G06V 30/30; G06V 30/41; H04N 1/346; G06Q 30/04

(57) ABSTRACT

An information processing apparatus includes a processor configured to: obtain image data; obtain information including at least one of setting information set in advance for optical character recognition processing by plural apparatuses capable of communicating with the information processing apparatus or attribute information of each of the plural apparatuses; and based on the obtained image data and the obtained information, determine an apparatus used for optical character recognition processing of the image data from among the plural apparatuses.

### CROSS-REFERENCE TO RELATED APPLICATIONS

This application is based on and claims priority under 35 USC 119 from Japanese Patent Application No. 2022-007061 filed Jan. 20, 2022.

### BACKGROUND

### (i) Technical Field

The present disclosure relates to an information processing apparatus, a non-transitory computer readable medium, and an information processing method.

### (ii) Related Art

For example, Japanese Unexamined Patent Application Publication No. 2018-124810 discloses an image forming apparatus including the following: an obtaining unit that obtains manuscript image data; a communication interface for communicating with an external apparatus that performs first optical character recognition processing on the manuscript image data; an optical character recognition processor that performs second optical character recognition processing, which is simpler processing than the first optical character recognition processing; and a controller that determines whether to execute the first optical character recognition processing on the basis of a result of recognition by the second optical character recognition processing, and generates a document file using at least one of a result of the first optical character recognition processing or a result of the second optical character recognition processing in accordance with the result of the determination.

Here, in the case where a user selects an apparatus for performing optical character recognition processing from among a plurality of apparatuses, it is difficult to select the apparatus according to the situation, and, if the number of apparatuses increases, it is assumed that the user's burden in selecting the apparatus increases.

### SUMMARY

Aspects of non-limiting embodiments of the present disclosure relate to reducing, as compared to the case where a user selects an apparatus that performs optical character recognition processing from among a plurality of apparatuses, the user's burden in selecting the apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: obtain image data; obtain information including at least one of setting information set in advance for optical character recognition processing by a plurality of apparatuses capable of communicating with the information processing apparatus or attribute information of each of the plurality of apparatuses; and based on the obtained image data and the obtained information, determine an apparatus used for optical character recognition processing of the image data from among the plurality of apparatuses.

### BRIEF DESCRIPTION OF THE DRAWINGS

Exemplary embodiments of the present disclosure will be described in detail based on the following figures, wherein:

FIG. 1 is a diagram describing the configuration of an information processing system;

FIG. 2 is a functional block diagram of an image forming apparatus;

FIG. 3 is a functional block diagram of a server apparatus;

FIGS. 4A and 4B are diagrams describing exemplary information obtained by an information obtaining unit, FIG. 4A illustrating setting information as exemplary information, and FIG. 4B illustrating attribute information as exemplary information;

FIGS. 5A and 5B are diagrams describing a user interface (UI) for a user to enter attribute information,

FIG. 5A illustrating a server apparatus selection screen, and FIG. 5B illustrating a screen for entering optical character recognition (OCR) information for a selected server apparatus;

FIG. 6 is a flowchart describing a process of automatically obtaining attribute information;

FIG. 7 is a diagram describing a first example as an exemplary process in the case where the image forming apparatus obtains image data;

FIG. 8 is a diagram describing a second example as an exemplary process in the case where the image forming apparatus obtains image data;

FIG. 9 is a flowchart illustrating a process in a first exemplary embodiment;

FIG. 10 is a flowchart illustrating an analysis process using a built-in OCR in step S204;

FIG. 11 is a flowchart illustrating a cloud OCR selection process in step S209;

FIG. 12 is a diagram describing an exemplary screen of the UI in the case where a process in a second exemplary embodiment is performed; and

FIGS. 13A and 13B are diagrams describing an exemplary screen of the UI in the case where a process in a third exemplary embodiment is performed, FIG. 13A illustrating one example, and FIG. 13B illustrating another example.

### DETAILED DESCRIPTION

Hereinafter, exemplary embodiments of the present disclosure will be described in detail with reference to the accompanying drawings.

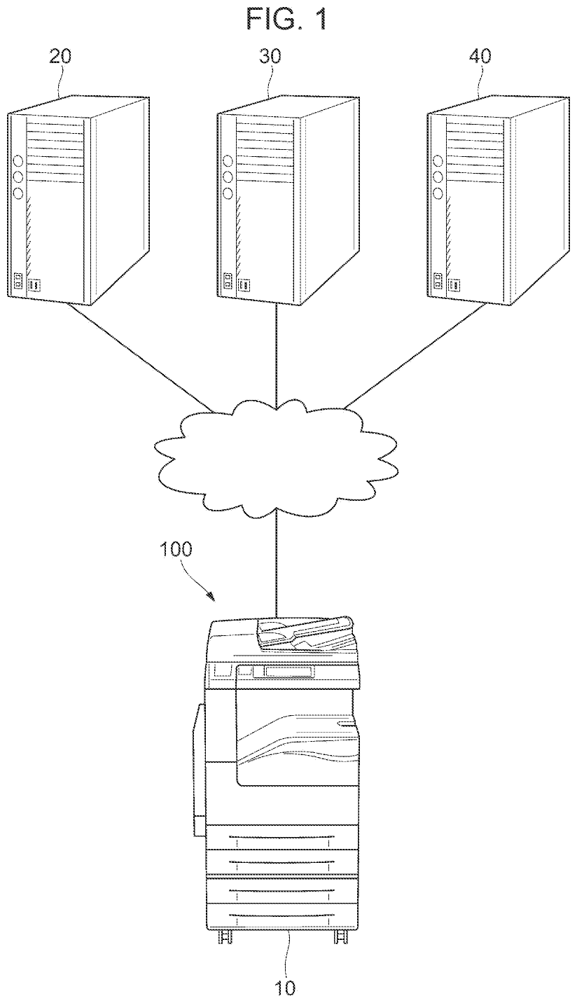

FIG. 1 is a diagram describing the configuration of an information processing system 100.

The information processing system 100 illustrated in FIG. 1 includes an image forming apparatus 10 for printing an image on paper. The image forming apparatus 10 is connected to server apparatuses 20, 30, and 40 to be able to communicate with them.

As a network for connecting the image forming apparatus 10 and the server apparatuses 20 to 40, for example, a local area network (LAN) or the Internet is used. Needless to say, the network may be configured as a composite type including a LAN and the Internet.

In addition to a function of printing an image on paper, the image forming apparatus 10 also includes a scanning function of optically reading an image of a manuscript or the like, and an optical character reader (OCR) function of optically recognizing the read image as characters. The image forming apparatus 10 is also referred to as a multifunctional peripheral (MFP). In addition, the image forming apparatus 10 may be a so-called production printer used for professional printing. Note that the functions listed for the image forming apparatus 10 are only exemplary, and do not prevent other functions from being provided.

For the printing function of the image forming apparatus 10, besides using an electrophotographic method in which a toner adhered to a charged and exposed photosensitive body is transferred to a recording material to fix and form an image, for example, an inkjet method in which ink is ejected onto a recording material to form an image may be used.

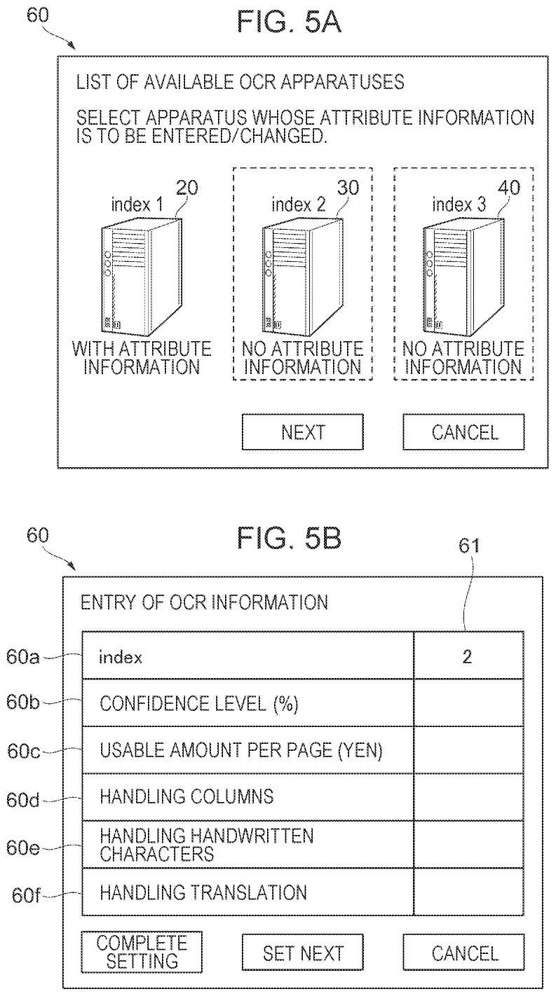

The image forming apparatus 10 includes an operation display unit (for example, see a user interface (UI) 60 illustrated in FIGS. 5A and 5B described later) including a display that displays various images for operation and various types of information to be reported to a user, and an input unit where various buttons for input are arranged according to an operation image on the display. Note that the operation display unit mentioned here may be configured to form a display screen with a touchscreen, and, with the touchscreen, the functions of the display and the input unit may be provided.

Note that the image forming apparatus 10 may be replaced with an information processing apparatus such as a personal computer (PC) or a mobile information terminal such as a smartphone (none of them are illustrated). The image forming apparatus 10 is also an example of an information obtaining apparatus.

The server apparatuses 20 to 40 are configured as shared servers that provide so-called cloud services, and are located in a cloud environment operated at facilities owned by external business operators. More specifically, each of the server apparatuses 20 to 40 is equipped with the above-mentioned OCR function.

Accordingly, the image forming apparatus 10 and the server apparatuses 20, 30, and 40 each have an OCR function; while the OCR function of the image forming apparatus 10 may be referred to as a “built-in OCR”, the OCR function of each of the server apparatuses 20, 30, and 40 may be referred to as a “cloud OCR”. In the case where a cloud OCR is a paid service, for example, a usage amount per page may be set, or a fixed fee may be set for a predetermined number of pages, and, if processed pages exceed the predetermined number of pages, an additional fee may be charged.

Note that each of the server apparatuses 20 to 40 may physically be one computer, or may be realized by distributed processing performed by a plurality of computers. Moreover, each of the server apparatuses 20 to 40 in the present exemplary embodiment is configured as a shared server that provides so-called cloud services.

Here, a built-in OCR and a cloud OCR may have different features, such as performance including processing speed and accuracy, and processing cost. For example, a built-in OCR is characterized in that it has high processing speed but low accuracy, whereas a cloud OCR is characterized in that it is capable of analyzing columnated text at high cost, and it is also capable of analyzing non-columnated text with high accuracy and at low cost.

For this reason, the user needs to determine the processing request destination after grasping the features of each OCR. In particular, when there are multiple cloud OCRs available, it is difficult to select a cloud OCR that matches a document subjected to OCR processing. The more cloud OCRs available, the more cloud OCR choices the user has but the greater the burden of selection for the user, which may be less user-friendly.

Therefore, in the present exemplary embodiment, on receipt of an instruction for performing OCR processing, the image forming apparatus 10 selects whether to perform processing using a built-in OCR or a cloud OCR on the basis of document data, presetting, etc., and, in the case of performing processing using a cloud OCR, the user's burden in selecting a cloud OCR from among a plurality of cloud OCRs that are available is reduced.

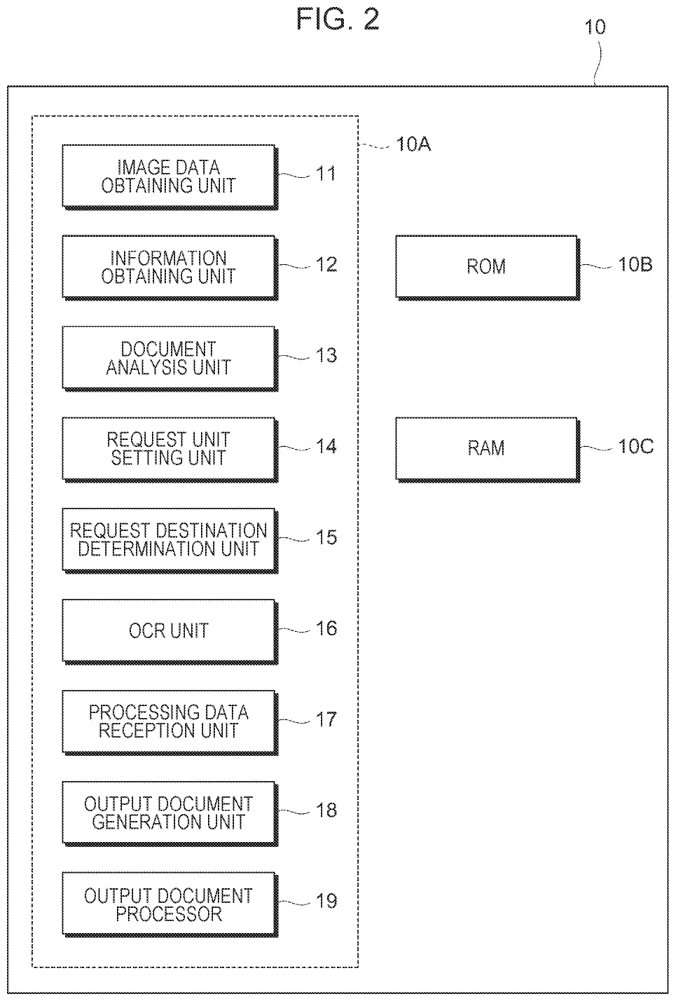

Hereinafter, this will be specifically described. FIG. 2 is a functional block diagram of the image forming apparatus 10.

As illustrated in FIG. 2, the image forming apparatus 10 includes an image data obtaining unit 11, an information obtaining unit 12, a document analysis unit 13, a request unit setting unit 14, a request destination determination unit 15, an OCR unit 16, a processing data reception unit 17, an output document generation unit 18, and an output document processor 19.

The image data obtaining unit 11 obtains image data as a target to be processed. Such data may be obtained using, besides the scanning function of the image forming apparatus 10, transmission of data from the outside.

In addition, the image data obtaining unit 11 obtains information indicating processing of image data. The information indicating processing mentioned here is presetting done by the user, and is information that specifies the contents of processing. For example, the information may be information indicating that OCR processing is to be performed, or may be information indicating that, after the OCR processing, translation into another language is to be performed. In addition, the information may be information that specifies whether the OCR processing is performed with priority on speed or reproducibility.

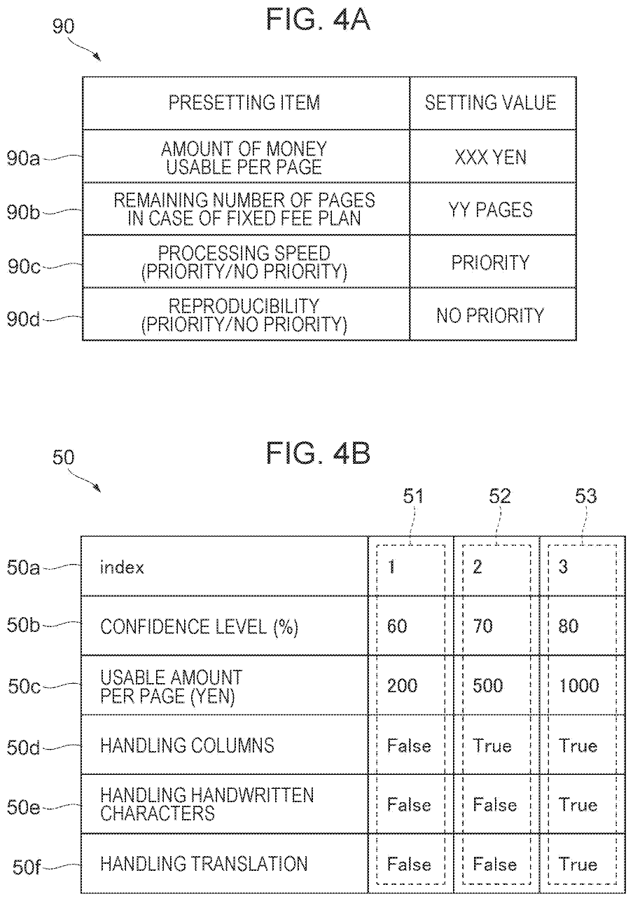

The information obtaining unit 12 obtains setting information (see example of setting information 90 illustrated in FIG. 4A) determined in advance by the user for processing performed by the server apparatuses 20 to 40. The setting information mentioned here may be information on billing. An example of the information on billing includes information indicating an acceptable upper limit value per page. Another example of the information on billing includes information indicating, in the case of a fixed fee until the number of pages subjected to OCR processing exceeds a predetermined value, the number of processed pages or the number of pages until the predetermined value is reached.

Moreover, the information obtaining unit 12 provides information (see FIG. 4A) indicating that, as setting information entered by the user in the case of performing OCR processing using the server apparatuses 20 to 40, processing is performed with priority on processing speed or reproducibility.

In addition, the information obtaining unit 12 obtains attribute information (see an example of attribute information 50 illustrated in FIG. 4B) of each of the server apparatuses 20 to 40 performing processing. The attribute information mentioned here may be, besides information entered by user operation, information obtained from the server apparatuses 20 to 40.

The attribute information may be information on the notation aspect of characters or the language of characters in each of the server apparatuses 20 to 40. The information on the notation aspect of characters includes information indicating whether each server apparatus is capable of handling columns or handwritten characters. The information on the language of characters includes whether each server apparatus is capable of handling translation. Moreover, the information on the notation aspect of characters includes the direction of lines of the characters, that is, whether each server apparatus is capable of handling vertical writing, or whether each server apparatus is capable of handling ruby characters, which are furigana (Japanese reading aids).

Besides obtaining the above-described setting information and attribute information, the information obtaining unit 12 may not obtain attribute information while obtaining setting information, or may not obtain setting information while obtaining attribute information. That is, the information obtaining unit 12 obtains at least one of setting information or attribute information. Information including the setting information and/or attribute information obtained by the information obtaining unit 12 may be simply referred to as “information”.

The document analysis unit 13 conducts a document analysis of the obtained image data using a result obtained by the OCR unit 16, which is a built-in OCR. As a result of the document analysis mentioned here, it is determined whether there are columns of text, whether there are handwritten characters, whether the characters are characters of a language other than Japanese, and so forth. In the case where there are columns of text, the number of columns may be identified. The clause “there are handwritten characters” mentioned here includes cases where all the characters are handwritten characters, and also includes cases where printed characters and handwritten characters are mixed.

In addition, in the case where the image data includes illustrations, the document analysis unit 13 may identify the number of illustration areas or identify the number of character areas.

Furthermore, the document analysis unit 13 may determine whether the writing is vertical or horizontal, whether ruby characters are included, and so forth.

The request unit setting unit 14 sets a unit for determining an apparatus used for OCR processing of the image data from among the server apparatuses 20 to 40. The request unit setting unit 14 sets the unit in response to user operation.

The unit mentioned here is a predetermined unit determined in advance for an image, such as being all of the image data or a part of the image data. In the case where the unit is a part of the image data, the unit may be a unit of one page, or a partial unit on one page of the image data.

The unit mentioned here refers to a unit in the case where some or all of the server apparatuses 20 to 40 are requested to perform OCR processing of image data obtained by the image data obtaining unit 11. More specifically, besides the mode of requesting any one of the server apparatuses 20 to 40 to perform OCR processing of all of the image data, there are the following modes: the mode in which, when some of the server apparatuses 20 to 40 are requested to perform OCR processing, one page or plural pages serve as a unit; and the mode in which, when one page is divided into three parts, one or two parts serve as a unit.

The request destination determination unit 15 determines a request destination(s) from among the server apparatuses 20 to 40 on the basis of information obtained by the information obtaining unit 12 and the result of analyzing image data by the document analysis unit 13. In addition, using request unit setting information of the request unit setting unit 14, the request destination determination unit 15 may determine any one or multiple request destinations from among the server apparatuses 20 to 40.

The request destination determination unit 15 sends image data and necessary information to the determined request destination(s).

Although the request destination determination unit 15 determines a request destination(s) from among the server apparatuses 20 to 40, which are cloud OCRs, this is not the only possible case, and the request destination determination unit 15 may determine whether to use a cloud OCR or a built-in OCR.

The OCR unit 16 is a portion corresponding to the above-mentioned built-in OCR.

Note that the OCR unit 16 may generate OCR data, which serves as the basis for an analysis conducted by the above-described document analysis unit 13, or may perform OCR processing of image data obtained by the image data obtaining unit 11 together with or in place of the server apparatuses 20 to 40.

The processing data reception unit 17 receives an OCR-processed processing result or processing data from the server apparatus(es) 20 to 40 that has/have been requested to perform OCR processing.

The output document generation unit 18 generates an output document or an output document file corresponding to the image data on the basis of the processing data received by the processing data reception unit 17.

For the output document generated by the output document generation unit 18, the output document processor 19 performs processing such as printing of the output document locally or transferring the output document to another apparatus.

Here, each function of the image forming apparatus 10 is realized by a central processing unit (CPU) 10A, which is an example of a processor. The CPU 10A reads a program stored in read-only memory (ROM) 10B, sets random-access memory (RAM) 10C as a work area, and executes the program. The program executed by the CPU 10A may be provided to the image forming apparatus 10 by being stored in a computer-readable recording medium, such as a magnetic recording medium (magnetic tape, magnetic disk, etc.), an optical recording medium (such as an optical disk), a magneto-optical recording medium, or a semiconductor memory. In addition, the program executed by the CPU 10A may be downloaded to the image forming apparatus 10 using communication means such as the Internet.

Although each function of the image forming apparatus 10 is realized by software in the present exemplary embodiment, this is not the only possible case, and each function may be realized by, for example, an application specific integrated circuit (ASIC).

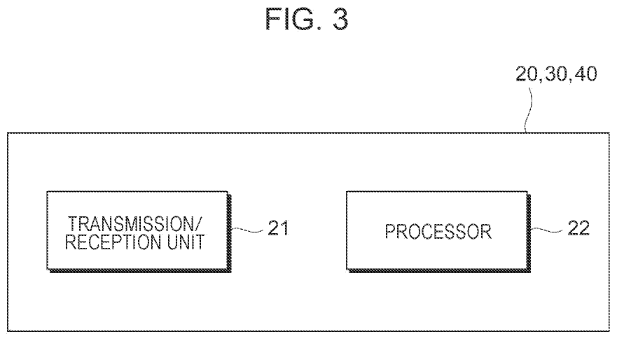

FIG. 3 is a functional block diagram of the server apparatus 20.

As illustrated in FIG. 3, the server apparatus 20 includes a transmission/reception unit 21 and a processor 22. Although reference numerals 30 and 40 are indicated in parentheses in FIG. 3, this represents that the functional block diagrams of the other server apparatuses 30 and 40 may be common with the server apparatus 20.

The transmission/reception unit 21 performs transmission/reception to/from the image forming apparatus 10. That is, the transmission/reception unit 21 receives image data and necessary information from the request destination determination unit 15, and transmits processing data obtained by the processor 22 to the image forming apparatus 10.

The processor 22 is a portion that corresponds to the above-described cloud OCR, and performs OCR processing in response to a request from the image forming apparatus 10. The processor 22 may perform translation processing, for example, besides OCR processing.

Next, the obtaining of information by the information obtaining unit 12 of the image forming apparatus 10 will be described using FIGS. 4A to 6.

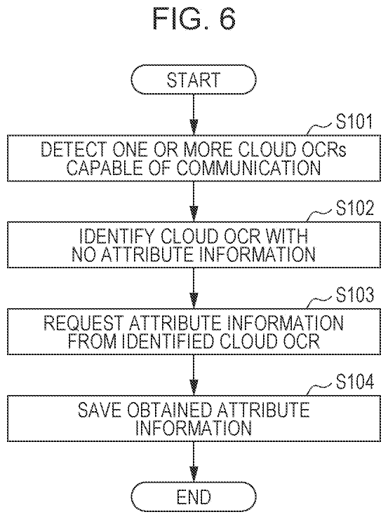

FIGS. 4A and 4B are diagrams describing exemplary information obtained by the information obtaining unit 12. FIG. 4A illustrates the setting information 90 as exemplary information, and FIG. 4B illustrates the attribute information 50 as exemplary information. FIGS. 5A and 5B are diagrams describing the UI 60 with which the user enters the attribute information 50. FIG. 5A illustrates a screen for selecting one or more of the server apparatuses 20 to 40, and FIG. 5B is a screen for entering OCR information for the selected server apparatus 30. FIG. 6 is a flowchart describing a process of automatically obtaining the attribute information 50.

In the example of the setting information 90 illustrated in FIG. 4A, fields for presetting by the user include the following: an amount-of-money-usable-per-page (hereinafter referred to as a usable amount) field 90a; a remaining-number-of-pages in the case of a fixed fee plan (hereinafter referred to as a remaining-number-of-pages) field 90b; a processing speed field 90c; and a reproducibility field 90d.

The usable amount field 90a and the remaining-number-of-pages field 90b are examples of information on billing.

The usable amount field 90a is a field for setting a cost assumed by the user, where the user is able to enter in advance an acceptable upper limit value per page of OCR processing. Therefore, depending on the value in the usable amount field 90a, any of the server apparatuses 20 to 40 may be unavailable. Note that the usable amount field 90a is a field entered by the user in the case where a contract is concluded in a pay-as-you-go system in which the cost of OCR processing is determined according to the number of pages.

The remaining-number-of-pages field 90b is a field for setting a cost, like the usable amount field 90a, but, unlike the usable amount field 90a, the remaining-number-of-pages field 90b is a field entered by the user in the case where a contract is concluded in a fixed fee plan in which, while the fee is fixed until a predetermined number of pages, once the processed pages exceed that number of pages, a pay-as-you-go system is employed. Therefore, a user who wants to reduce the cost enters the number of pages determined in advance by the contract as the remaining number of pages, and, with the request destination determination unit 15 (see FIG. 2) of the image forming apparatus 10, the server apparatuses 20 to 40 may be properly used.

In the case of the present exemplary embodiment, the usable amount field 90a and the remaining-number-of-pages field 90b are entered by the user according to the contract of each of the server apparatuses 20 to 40. Whereas the predetermined number of pages is entered in the remaining-number-of-pages field 90b, for example, the request destination determination unit 15 or the processing data reception unit 17 (see FIG. 2) of the image forming apparatus 10 may obtain information indicating the number of OCR-processed pages, and update the entered number of pages to a value obtained by subtracting the number of OCR-processed pages from the entered number of pages. Moreover, the number of OCR-processed pages may be entered by the user or automatically updated in the remaining-number-of-pages field 90b.

In addition, a full-flat-rate contract where the fee is fixed regardless of the number of pages is also conceivable; in such a case, a full-flat-rate field is provided in place of the remaining-number-of-pages field 90b.

The processing speed field 90c and the reproducibility field 90d are fields for entering information used when selecting an apparatus that performs OCR processing, and the user is able to specify whether to place priority on processing speed or reproducibility in the case of performing OCR processing. In the setting information 90 illustrated in FIG. 4A, it is specified that priority is placed on processing speed, not on reproducibility.

Next, the attribute information 50 will be described.

The example of the attribute information 50 illustrated in FIG. 4B includes the following fields: an index field 50a, a confidence level field 50b, a usage-amount-per-page (hereinafter referred to as a usage amount) field 50c, a column handling field 50d, a handwritten-character handling field 50e, and a translation handling field 50f. Fields other than those illustrated in FIG. 4B, such as a vertical-writing handling field or a ruby-character handling field, may be included.

The attribute information 50 includes attribute information 51 for each item of the server apparatus 20, attribute information 52 for each item of the server apparatus 30, and attribute information 53 for each item of the server apparatus 40.

The index field 50a of the attribute information 50 is a field indicating a serial number given by the information obtaining unit 12, and “1” is given to the attribute information 51 of the server apparatus 20. “2” is given to the attribute information 52 of the server apparatus 30, and “3” is given to the attribute information 53 of the server apparatus 40.

FIG. 4B illustrates information obtained by the information obtaining unit 12 for cloud OCRs. However, because attribute information of a built-in OCR is stored in the ROM 10B (see FIG. 2) of the image forming apparatus 10 and is not obtained by the information obtaining unit 12, attribute information of a built-in OCR is not illustrated in FIG. 4B.

The confidence level field 50b of the attribute information 50 is a field indicating a confidence level, which is an index indicating the performance of OCR processing. The confidence level mentioned here is set by the manufacturer to the apparatus performing OCR processing, which is a value representing the certainty of the character recognition result and which is a concept different from reading accuracy.

The higher the confidence level, the lower the proportion or frequency that the user makes corrections to the OCR processing result. The lower the confidence level, the higher the user's correction proportion or correction frequency. For example, the confidence level may be a proportion calculated on the basis of information corrected by the user on the recognition result.

In addition, the confidence level in the case of handwriting OCR that recognizes handwritten characters may be obtained by making the degree of similarity between an input image of handwritten characters and the recognition result as a rule using character recognition technology combined with the human visual mechanism.

In the example illustrated in FIG. 4B, the confidence level of index 1 is 60%, the confidence level of index 2 is 70%, and the confidence level of index 3 is 80%. Therefore, it is likely that the user will have to correct more portions of the OCR processing result of index 1 than the case of index 3.

The usage amount field 50c is a field indicating a unit usage fee per page in the case of performing OCR processing, and is set according to the performance of OCR processing. The usage fee for OCR processing is the amount obtained by multiplying the unit usage fee by the number of pages.

In the example illustrated in FIG. 4B, different fees are set to the server apparatuses 20 to 40. The fee of index 1 is 200 yen per page, the fee of index 2 is 500 yen per page, and the fee of index 3 is 1000 yen per page.

The column handling field 50d is a field indicating whether it is possible to perform OCR processing of columnated text. In the example illustrated in FIG. 4B, while index 1 is unable to handle columns, indices 2 and 3 are able to handle columns.

Note that columns are used for preventing a decrease in readability due to an increase in the number of characters of one line, and two or three columns are set to have a layout where the characters are easy to read. In addition, ruled lines may be used as separations of columns.

The handwritten-character handling field 50e is a field indicating whether it is possible to perform OCR processing in the case where a to-be-processed target includes handwritten characters instead of printed characters. In the example illustrated in. FIG. 4B, while indices 1 and 2 are unable to handle handwritten characters, index 3 is able to handle handwritten characters.

The translation handling field 50f is a field indicating whether it is possible to perform translation processing after OCR processing. In the example illustrated in FIG. 4B, while indices 1 and 2 are unable to handle translation, index 3 is able to handle translation. Such translation processing is a process of translating the OCR processing result into a language other than the language of the OCR processing result. The OCR processing result may be translated from Japanese into a foreign language, or from a foreign language into Japanese.

The column handling field 50d and the handwritten-character handling field 50e of the attribute information 50 are items of information on characters included in image data and are items of information on the notation aspect of the characters. The information on the notation aspect of the characters mentioned here is information indicating how the characters included in the image data are notated, and includes, for example, besides information indicating the presence or absence of columns, information indicating the number of columns when there are columns, and information indicating the presence or absence of handwritten characters. The information on characters included in image data mentioned here is information necessary for performing OCR processing of the characters included in the image data, and includes not only information on the notation aspect of the characters, but also information indicating whether the language of the characters is Japanese or a foreign language. In the case where the language of the characters is a foreign language, the information may include information necessary for translation processing, such as information indicating a specific language such as English.

The column handling field 50d and the handwritten-character handling field 50e are examples of information on characters included in image data, and are examples of information on the notation aspect of the characters. The translation handling field 50f of the attribute information 50 is an example of information on characters included in image data.

Here, a method of obtaining, by the information obtaining unit 12 (see FIG. 2), information in each field of the attribute information 50 for a cloud OCR will be described. The obtaining method mentioned here may be performed using user entries illustrated in FIGS. 5A and 5B, and a control method illustrated in FIG. 6.

The UI 60 illustrated in FIGS. 5A and 5B illustrating the case of user entries is an operation display unit of the image forming apparatus 10 and is composed of a touchscreen.

An exemplary screen of the UI 60 illustrated in FIG. 5A displays a list of OCR apparatuses that are available. The user is able to select an apparatus whose attribute information is to be entered or changed. In the example illustrated in FIG. 5A, index 1 (server apparatus 20) has the attribute information already entered, and the attribute information of indices 2 and 3 (server apparatuses 30 and 40) has not been entered.

Indices 2 and 3 are selected from among indices 1 to 3. The state in which indices 2 and 3 are selected is indicated by broken-line frames.

After that, the user may press a “Next” button illustrated in FIG. 5A to display an exemplary screen illustrated in FIG. 5B on the UI 60.

The UI 60 illustrated in FIG. 5B displays an exemplary screen for entering OCR information. The exemplary screen includes the following fields: an index field 60a, a confidence level field 60b, a usable amount field 60c, a column handling field 60d, a handwritten-character handling field 60e, and a translation handling field 60f, which respectively correspond to the index field 50a, the confidence level field 50b, the usable amount field 50c, the column handling field 50d, the handwritten-character handling field 50e, and the translation handling field 50f of the above-described attribute information 50 (see FIG. 4B).

More specifically, “2” is already displayed in the index field of an input region 61 of the exemplary screen mentioned here, reflecting the selection result illustrated in FIG. 5A.

When the user finishes entering information into the screen illustrated in FIG. 5B, the user may press a “Complete setting” or “Set next” button to complete the input operation of the attribute information of index 2. Additionally, pressing the “Set next” button allows an input operation to be performed on the attribute information of index 3.

Next, the case where the information obtaining unit 12 (see FIG. 2) obtains attribute information through a control process will be described.

In the exemplary process illustrated in FIG. 6, the information obtaining unit 12 of the image forming apparatus 10 detects one or more cloud OCRs capable of communication (step S101) and further identifies a cloud OCR among the detected cloud OCRs that has no attribute information (step S102). The timing of such processing may be the arrival of a predetermined time.

Then, the information obtaining unit 12 requests attribute information from the cloud OCR identified as having no attribute information (step S103). Upon obtaining of the attribute information from the identified cloud OCR, the information obtaining unit 12 saves the obtained attribute information (step S104).

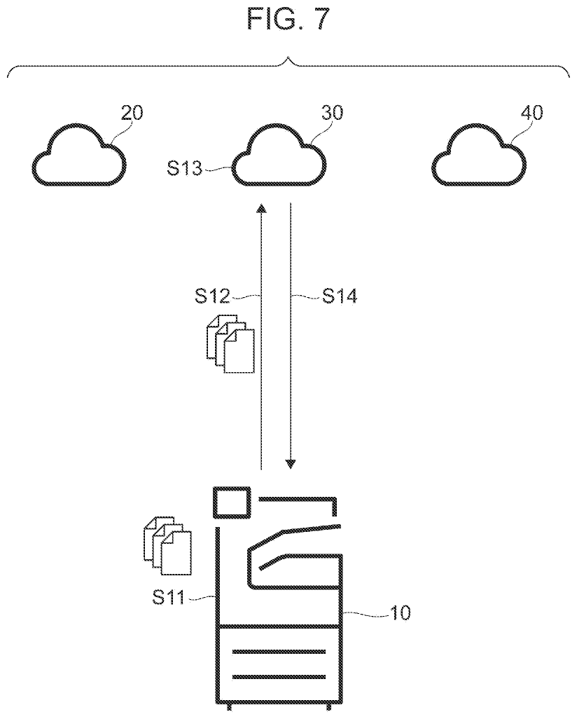

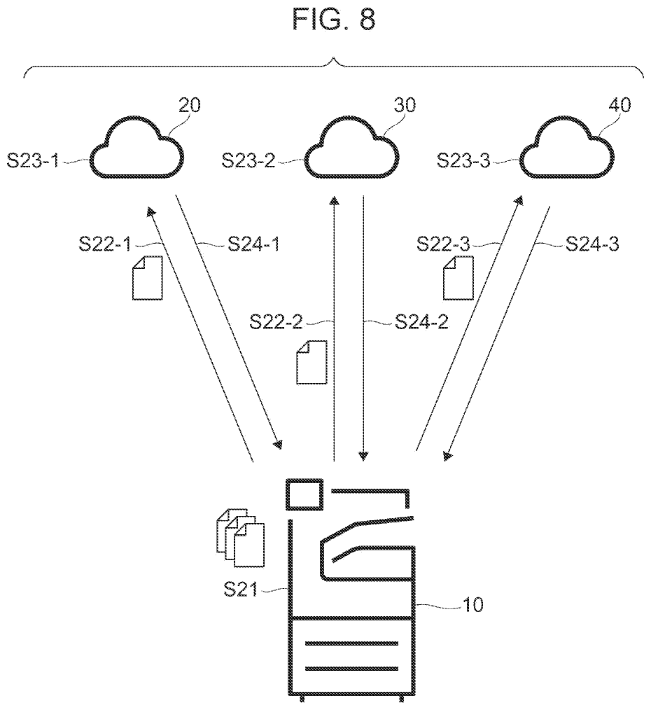

Next, an exemplary process in the case where the image forming apparatus 10 obtains image data will be described using FIGS. 7 and 8.

FIGS. 7 and 8 are diagrams illustrating an exemplary process in the case where the image forming apparatus 10 obtains image data. FIG. 7 illustrates a first example, and FIG. 8 illustrates a second example.

### First Example

FIG. 7 is a diagram illustrating the first example as an exemplary process in the case where the image forming apparatus 10 obtains image data.

In the first example illustrated in FIG. 7, in the image forming apparatus 10, when the image data obtaining unit 11 (see FIG. 2) obtains image data of a plurality of pages (step S11), the request destination determination unit 15 (see FIG. 2) determines an apparatus used for OCR processing of the image data from among the server apparatuses 20 to 40 on the basis of the information obtained by the information obtaining unit 12 (see FIG. 2). In the first example, the request unit is all of the image data, and the request destination is the server apparatus 30.

The request destination determination unit 15 transmits all of the image data to the server apparatus 30 and requests OCR processing (step S12). In the server apparatus 30, the processor 22 (see FIG. 3) performs OCR processing of the image data received by the transmission/reception unit 21 (see FIG. 3) in response to the request (step S13), and the transmission/reception unit 21 transmits the processing result to the image forming apparatus 10 (step S14).

In the image forming apparatus 10, the processing data reception unit 17 (see FIG. 2) receives the processing result, the output document generation unit 18 (see FIG. 2) generates an output document or an output document file, and the output document processor 19 (see FIG. 2) performs processing.

In addition, in the case of transmitting the image data, the request destination determination unit 15 may transmit all of the image data in bulk, or may transmit the image data in units of pages, as in the case of transmitting the image data of the first page and, on receipt of a processing result thereof, transmitting the image data of the second page.

### Second Example

FIG. 8 is a diagram illustrating the second example as an exemplary process in the case where the image forming apparatus 10 obtains image data.

In the second example illustrated in FIG. 8, like the first example, the image data obtaining unit 11 (see FIG. 2) obtains image data of a plurality of pages, specifically three pages (step S21). However, unlike the first example where all of the image data serves as the request unit, the request unit in the second example is a part of the image data, that is, per page.

The request destination determination unit 15 (see FIG. 2) determines the request destination for each of the three pages on the basis of the information obtained by the information obtaining unit 12 (see FIG. 2). In the second example, it is specified that each of the server apparatuses 20 to 40 is requested to process one page. Therefore, the request destination determination unit 15 transmits one page of the image data to each of the server apparatuses 20 to 40 and requests OCR processing (steps S22-1, S22-2, and S22-3).

Note that, even if the request unit is a part of the image data, it is also conceivable that any one of the server apparatuses 20 to 40 is determined as the request destination.

The server apparatuses 20 to 40 perform OCR processing of the received image data (steps S23-1, S23-2, step S23-3) and transmit the processing results to the image forming apparatus 10 (steps S24-1, S24-2, and S24-3).

On the basis of the received processing results, the image forming apparatus 10 generates and processes an output document or an output document file, like the first example.

### First Exemplary Embodiment

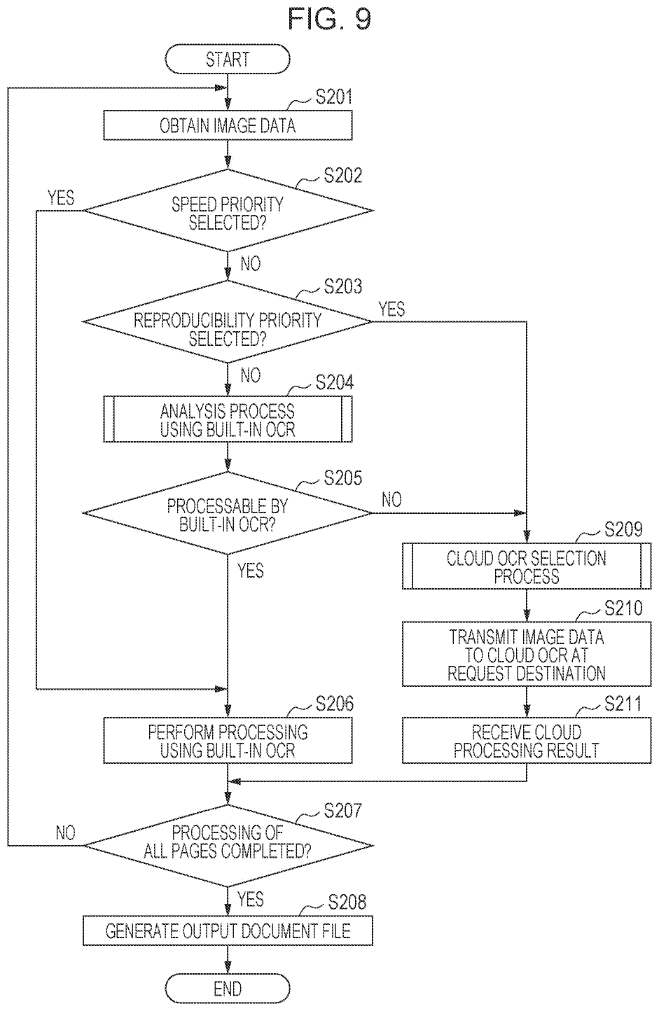

Next, a first exemplary embodiment will be described using FIGS. 9 to 11. That is, a more detailed exemplary process from the obtaining of image data (steps S11 and S21) to the generation of an output document or an output document file in the first example and the second example will be described as the first exemplary embodiment.

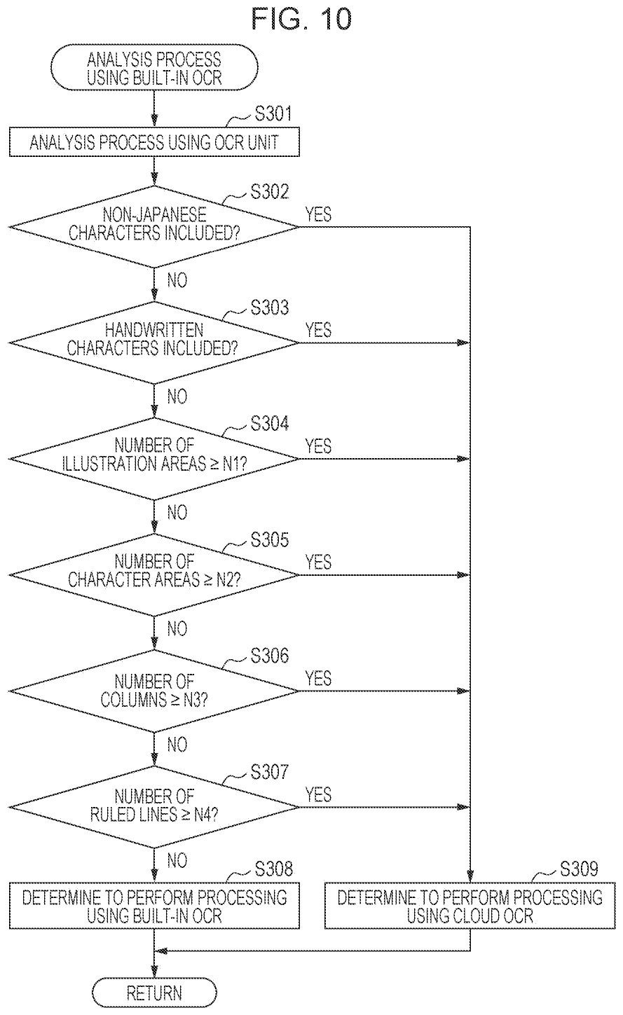

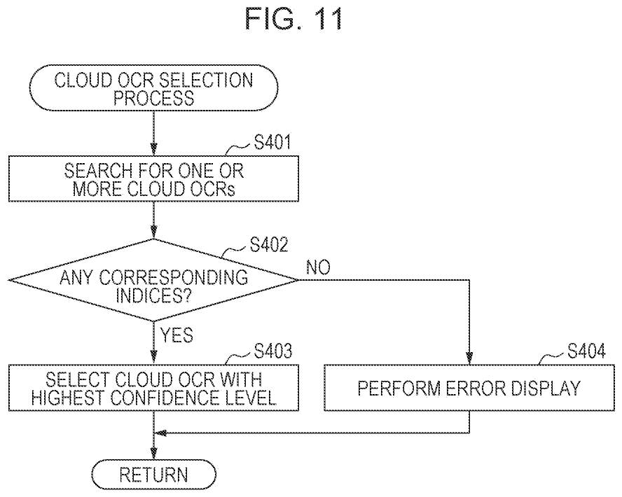

FIG. 9 is a flowchart illustrating a process in the first exemplary embodiment. FIG. 10 is a flowchart illustrating an analysis process using a built-in OCR in step S204 (see FIG. 9). FIG. 11 is a flowchart illustrating a cloud OCR selection process in step S209 (see FIG. 9).

In the first exemplary embodiment, as illustrated in FIG. 9, when the image data obtaining unit 11 (see FIG. 2) of the image forming apparatus 10 obtains image data (step S201), it is checked whether priority is placed on speed or reproducibility as the user's presetting (see the setting information 90 illustrated in FIG. 4A).

The user's presetting mentioned here may be included in information indicating processing of image data obtained by the image data obtaining unit 11 of the image forming apparatus 10, or may be information set in advance by the image forming apparatus 10.

Specifically, whether speed priority has been selected is determined by referring to the setting information 90 (see FIG. 4A) (step S202). If it is checked that speed priority has been selected (Yes in step S202), the process proceeds to step S206 described below for processing using a built-in OCR.

If speed priority has not been selected (No in step S202), it is checked whether reproducibility priority has been selected (step S203). If reproducibility priority has been selected (Yes in step S203), the process proceeds to step S209 described below for processing using a cloud OCR.

In the case where reproducibility priority has not been selected (No in step S204), an analysis process using a built-in OCR is performed (step S204). Details will be described later with reference to FIG. 10.

After the analysis process using a built-in OCR (step S204), the request destination determination unit 15 (see FIG. 2) determines whether to perform processing using a built-in OCR (step S205). In the case where it is determined not to perform processing using a built-in OCR (No in step S205), the process proceeds to step S209 described later for processing using a cloud OCR.

In the case where it is determined to perform processing using a built-in OCR (Yes in step S205), processing using the OCR unit 16 (see FIG. 2) is performed to generate a document file (step S206).

After that, it is determined whether the processing has been completed for all pages of image data (step S207), and, if it is not completed (No in step S207), the process returns to step S201; and, if it is completed (Yes in step S207), the output document generation unit 18 (see FIG. 2) generates an output document file (step S208). As necessary, processing is performed by the output document processor 19 (see FIG. 2).

In the first example, since the request unit is all of the image data, the request destination determined on the first page is also applied to subsequent pages. In contrast, in the case of the second example, since the request unit is a part of the image data, the request destination is determined for each page.

In the case of performing processing using a cloud OCR (Yes in step S203 or No in step s205), when a cloud OCR selection process is performed (step S209), the request destination determination unit 15 (see FIG. 2) transmits the image data to a cloud OCR at the request destination (step S210).

When the processing is completed using the cloud OCR at the request destination and the result is transmitted, the processing data reception unit 17 receives the cloud processing result (step S211). When the cloud processing result is received, the process proceeds to step S207.

Next, an analysis process using a built-in OCR in step S204 described above illustrated in FIG. 9 will be described using FIG. 10.

In the analysis process using a built-in OCR illustrated in FIG. 10, the OCR unit 16 (see FIG. 2) performs an analysis process (step S301), and it is determined whether to perform processing using a built-in OCR or a cloud OCR in accordance with the analysis result.

That is, in accordance with the analysis result of the image data, it is determined whether the image data includes non-Japanese characters (step S302), whether the image data includes handwritten characters (step S303), whether the number of illustration areas is greater than or equal to a threshold N1 (step S304), whether the number of character regions is greater than or equal to a threshold N2 (step S305), whether the number of columns is greater than or equal to a threshold N3 (step S306), and whether the number of ruled lines is greater than or equal to a threshold N4 (step S307).

Note that these thresholds N1 to N4 are preset by the user. The thresholds N1 to N4 may be the user's presetting in the case where presetting is done for each item of the obtained image data, or may be the user's presetting in the case where, after the presetting is done, the presetting is uniformly applied to the obtained image data.

If none of the above determinations in steps S302 to S307 is applicable, the image data subjected to the determinations is regarded as data that is processable by a built-in OCR, and it is determined to perform processing using a built-in OCR (step S308).

In contrast, if of the above determinations in steps S302 to S307 is applicable, the image data subjected to the determinations is regarded as data that is not processable by a built-in OCR, and it is determined to perform processing using a cloud OCR (step S309).

After the above determination, the process returns to step S210 (see FIG. 9) described above.

Next, a cloud OCR selection process in step S209 described above illustrated in FIG. 9 will be described using FIG. 11.

In the cloud OCR selection process illustrated in FIG. 11, the request destination determination unit 15 of the image forming apparatus 10 refers to the attribute information 50 (see FIG. 4B) obtained by the information obtaining unit 12, and searches for one or more cloud OCRs (step S401). That is, the determination is done using information in the usage amount field 50c, the column handling field 50d, the handwritten-character handling field 50e, and the translation handling field 50f of the attribute information 50.

More specifically, it is determined whether there is any attribute information 50 in which the usage amount per page in the case where processing is performed on the to-be-processed image data is less than or equal to the value in its usage amount field 50c. In addition, in the case where there are columns in the to-be-processed image data, it is determined whether there is any attribute information 50 where “True” is included in its column handling field 50d; in the case where the processing target includes handwritten characters, it is determined whether there is any attribute information 50 where “True” is included in its handwritten-character handling field 50e; and in the case where the processing target includes non-Japanese characters, it is determined whether there is any attribute information 50 where “True” is included in its translation handling field 50f.

Then, the request destination determination unit 15 determines whether there are corresponding indices (step S402). If there are corresponding indices (Yes in step S402), the process selects a cloud OCR with the highest value of the confidence level in the confidence level field 50b (see FIG. 4B) from among the corresponding indices (step S403).

If there are no corresponding indices (No in step S402), it means that there is no cloud OCR capable of performing processing, and an error display is performed (step S404). Note that such an error display may be, for example, the contents “There is no cloud OCR capable of performing processing”. Moreover, in the case of an error display, it may be instructed to reconfigure the conditions of the setting information 90 to be more moderate (see FIG. 4A), and to perform a cloud OCR selection process again. Second Exemplary Embodiment

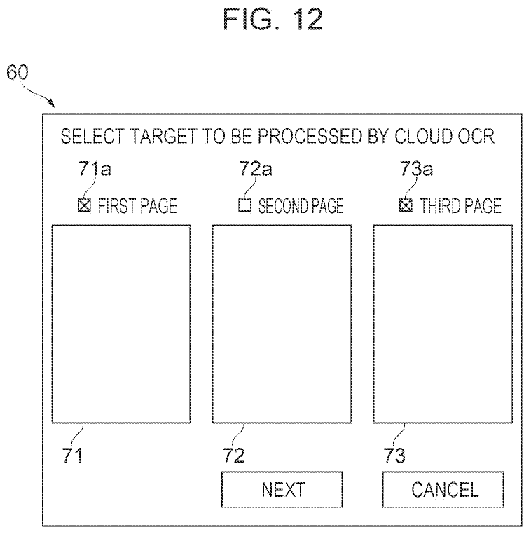

Next, a second exemplary embodiment will be described with reference to FIG. 12. The second exemplary embodiment relates to a process in which the user selects a target to be processed by a cloud OCR, and is performed in the cloud OCR selection process (see step S209 in FIG. 9 and FIG. 11). More specifically, an exemplary process added after the cloud OCR search (see step S401 in FIG. 11) will be described as the second exemplary embodiment.

FIG. 12 is a diagram describing an exemplary screen of the UI 60 in the case of performing the process in the second exemplary embodiment. The UI 60 is composed of a touchscreen.

The exemplary screen of the UI 60 in FIG. 12 displays a selection of a target to be processed by a cloud OCR. More specifically, the obtained image data includes three pages, and image data 71 of the first page, image data 72 of the second page, and image data 73 of the third page corresponding to the obtained image data are displayed. In addition, check boxes 71a to 73a corresponding to the items of image data 71 to 73 are also displayed.

The check boxes 71a to 73c indicate whether their corresponding items of image data 71 to 73 are selected as targets to be processed.

In the case of FIG. 12, a check mark is added to each of the check boxes 71a and 73a, but no check mark is added to the check box 72a. That is, the user has selected, from among the items of image data 71 to 73, the items of image data 71 and 73 as targets to be processed, but has not selected the image data 72. For this reason, the selection of a cloud OCR (see step S403) in the cloud OCR selection process (see step S209 in FIG. 9 and FIG. 11) is performed for the items of image data 71 and 73, but not for the image data 72.

### Third Exemplary Embodiment

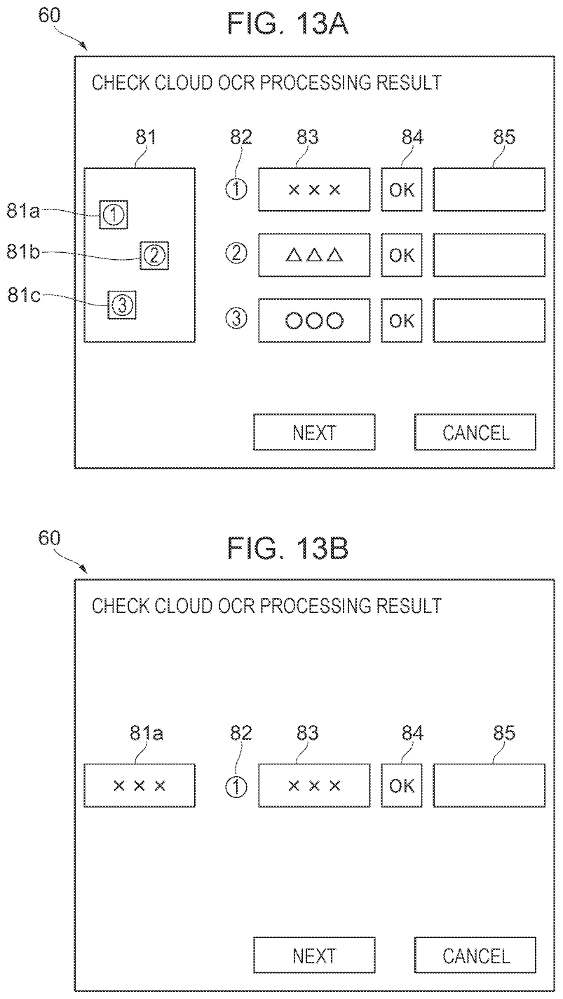

Next, a third exemplary embodiment will be described with reference to FIGS. 13A and 13B. The third exemplary embodiment relates to a process in which the user checks the result of processing performed by a cloud OCR, and is performed prior to the process of generating an output document file (step S208 of FIG. 9). In the third exemplary embodiment, instead of generating an output document file using the result of processing performed by a cloud OCR as it is, the user checks the result of processing performed by a cloud OCR and corrects portions to be corrected, thereby generating an output document file.

FIGS. 13A and 13B are diagrams describing an exemplary screen of the UI 60 in the case of performing the process in the third exemplary embodiment. FIG. 13A illustrates one example, and FIG. 13B illustrates another example. The third exemplary embodiment is different from the other exemplary embodiments in the point that a plurality of ranges are set on one page, and a cloud OCR is selected for each of the set ranges in the cloud OCR selection process (see step S209 in FIG. 9 and FIG. 11).

The exemplary screen of the UI 60 in FIG. 13A displays a selection of a target to be processed by a cloud OCR. More specifically, the obtained image data is image data 81 of one page, and three ranges 81a, 81b, and 81c that are targets subjected to OCR processing are set on the page.

The range 81a is marked with circled one (hereinafter referred to as <1>) as number 82. In addition, the range 81b is marked with circled two (hereinafter referred to as <2>) as number 82, and the range 81c is marked with circled three (hereinafter referred to as <3>) as number 82.

These numbers 82 mentioned here are arranged vertically on the right side of the image data 81.

The exemplary screen illustrated in FIG. 13A displays, on the right side of the numbers 82, processing results 83 corresponding to the numbers 82. The user checks the processing results 83 of the image data 81 by referring to the ranges 81a to 81c, and, if there is no need for correction, operates OK buttons 84; and, if corrections are necessary, the user enters corrections in input fields 85.

When the user finishes operating the OK button 84 or entering a correction in the input field 85 for each of <1> to <3> of the image data 81, the user operates “Next” to allow the output document generation unit 18 (see FIG. 2) to generate an output document file.

Note that <1> to <3> illustrated in FIG. 13A may have the same information on the characters or different items of information on the characters. Such differences may be, for example, differences in the notation aspect of the characters, such as the presence of columns or handwritten characters, or differences in characters in languages other than Japanese. In the case where <1> to <3> of the image data 81 have different items of information on the characters, the request destination which performs OCR processing of each of <1> to <3> of the image data 81 may be different, among the server apparatuses 20 to 40.

The other example illustrated in FIG. 13B corresponds to, like the above-described example illustrated in FIG. 13A, the case where the three ranges 81a, 81b, and 81c are set in the image data 81 of one page. An exemplary screen of the UI 60 illustrated in FIG. 13B includes, like the case illustrated in FIG. 13A, the number 82, the processing result 83, the OK button 84, and the input field 85.

Moreover, on the exemplary screen of the UI 60 illustrated in FIG. 13B, not all of the image data 81, but the contents of the range 81a appended with <1> are displayed on the left side. Accordingly, the user is able to check the processing result 83 while looking at the screen of the UI 60.

When the user finishes checking the range 81a, the user may operate “Next” to check the remaining ranges 81b and 81c sequentially.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively.

The order of operations of the processor is not limited to one described in the embodiments above, and may be changed. The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to:
obtain image data;
obtain information including at least one of setting information set in advance for optical character recognition processing by a plurality of apparatuses capable of communicating with the information processing apparatus or attribute information of each of the plurality of apparatuses; and
based on the obtained image data and the obtained information, determine an apparatus used for optical character recognition processing of the image data from among the plurality of apparatuses.

2. The information processing apparatus according to claim 1, wherein the setting information in a case where the setting information is included in the information is information on billing.

3. The information processing apparatus according to claim 2, wherein the information on billing is an acceptable upper limit value per page.

4. The information processing apparatus according to claim 2, wherein, in a case where the plurality of apparatuses include an apparatus of a fixed fee until a number of pages on which the optical character recognition processing is performed exceeds a predetermined value, the information on billing is information indicating a number of pages on which the optical character recognition processing has been performed or information indicating a number of pages until the predetermined value is reached.

5. The information processing apparatus according to claim 1, wherein the attribute information in a case where the attribute information is included in the information is information on characters included in the image data.

6. The information processing apparatus according to claim 5, wherein the information on characters included in the image data is information on a notation aspect of the characters.

7. The information processing apparatus according to claim 6, wherein the information on a notation aspect of the characters is information indicating whether there are columns.

8. The information processing apparatus according to claim 6, wherein the information on a notation aspect of the characters is information indicating whether there are handwritten characters.

9. The information processing apparatus according to claim 5, wherein the information on characters included in the image data is information indicating whether the characters are characters of a language other than Japanese.

10. The information processing apparatus according to claim 1, wherein the apparatus is determined for each predetermined unit determined in advance for the image data.

11. The information processing apparatus according to claim 10, wherein the predetermined unit is a part of the image data.

12. A non-transitory computer readable medium storing a program causing an information processing apparatus to execute a process, the process comprising:
obtaining image data;
obtaining information including at least one of setting information set in advance for optical character recognition processing by a plurality of apparatuses capable of communicating with the information processing apparatus or attribute information of each of the plurality of apparatuses; and
based on the obtained image data and the obtained information, determining an apparatus used for optical character recognition processing of the image data from among the plurality of apparatuses.

13. An information processing method comprising:
obtaining image data;
obtaining information including at least one of setting information set in advance for optical character recognition processing by a plurality of apparatuses capable of communicating with the information processing apparatus or attribute information of each of the plurality of apparatuses; and
based on the obtained image data and the obtained information, determining an apparatus used for optical character recognition processing of the image data from among the plurality of apparatuses.
